(19) United States
(12) Patent Application Publication
(10) Pub. No.: US 2014/0166685 A1
(43) Pub. Date: Jun. 19, 2014

(54) APPARATUS AND PROCESS FOR DISPENSING CUVETTES

(71) Applicant: DIAGON Kft., Budapest (HU)

(72) Inventor: Matyas Petoe, Budapest (HU)

(73) Assignee: DIAGON Kft., Budapest (HU)

(21) Appl. No.: 14/186,922

(22) Filed: Feb. 21, 2014

Related U.S. Application Data
(63) Continuation-in-part of application No. PCT/HU2012/000028, filed on Apr. 16, 2012.
(60) Provisional application No. 61/793,232, filed on Mar. 15, 2013.

(30) Foreign Application Priority Data
Aug. 22, 2011 (HU) P1100456

(51) Int. Cl. B65G 47/14

(52) U.S. Cl. CPC B65G 47/1414
USPC 221/1; 221/165

(57) ABSTRACT

Apparatus and processes for forwarding of cuvettes stored unarranged, in which, from a storage place, the cuvettes are forwarded for further use in an arranged way. The unarranged cuvettes have a suitable geometry, and are elevated between the edges of arranging cuvette elevator members, being elevated up to the output opening for arranged cuvettes. Through an output opening, the cuvettes arranged side by side are removed and are forwarded by a cuvette-advancing pusher (21) operated along the edges (19) of the raised arranging elements (18) by a drive mechanism. The cuvette elevators (18) are subsequently returned to their initial position at a bottom having two slight inclines (17).

This application claims benefit as a non-provisional of copending U.S. provisional appl. No. 61/793,232 filed on Mar. 15, 2013, and the present application claims benefit as a C-I-P continuation-in-part of copending PCT International application no. PCT/HU2012/000028 filed on Apr. 16, 2012 designating the U.S., claiming benefit of priority to prior Hungarian national application no. HU-P1100456 filed on Aug. 22, 2011, this priority claim being identically applicable to the present application, and U.S. provisional appl. Ser. No. 61/793,232 as well as parent PCT appl. no. PCT/HU2012/000028 are entirely incorporated herein by reference in their entireties and as to all their parts, for all intents and purposes, as if identically set forth in full herein.

The present disclosure relates to processes for dispensing cuvettes, and apparatus for this purpose. In automatic measuring devices, with the present solutions, cuvettes from an unarranged receptacle are arranged in an order for the purpose of further applications, with the goal of ensuring that the optically transparent surfaces of the arranged cuvettes are not so exposed to scratching, abrasive effects.

At present, the automation of manufacturing-research-development work processes on different areas of agriculture and industry has become an everyday phenomenon. Possibilities of automation involve, for example, the movement of the object to be worked or the vessel containing the substance to be tested, or the dispensing of some kind of unit to the next steps of the work process. Other possibilities of automation, for example for diagnostic tasks (for example in areas such as human healthcare, plant and animal health, industrial quality control, building industry, geology, meteorology, archaeology, etc.), lie in controlled dispensing in special devices to ensure the successiveness of the individual steps of the series of tasks, such as for example the dispensing of (small) vessels containing samples or reagents from a stored set, as required. The units to be dispensed mentioned above are dispensed and forwarded in a controlled way from an arranged or unarranged stored set.

As a possible form of realisation of subject procedures, the cuvette dispensing apparatus is presented in an automatic device specially designed for in vitro blood coagulation diagnostics, noting in addition that our procedure may be extended to any other automatic device, to the controlled movement of any other suitably constructed object to be worked or (small) vessel containing the substance to be tested or unit to be dispensed.

In automatic devices used for in vitro blood coagulation diagnostics, a continuous supply of cuvettes accommodating the tested reaction space is required for the large number of measurements. In solutions provided, with the aid of a cuvette dispensing apparatus, the cuvettes are transported from the cuvette holder to the cuvette accommodating place in the device, from where they are forwarded by a moving system to incubating and measuring points. The technical construction of the cuvette dispensing apparatus depends on how the cuvettes are stored before they are dispensed.

Cuvettes may be stored in a form arranged side by side and fixed to each other by means of a flexible film. In such arrangements the automatic device forwards the individual cuvettes to the measuring point by moving the film (see: published patent appln. no. US2005/0175502A1). The advantage of this arrangement is the arranged storage of cuvettes ensuring mechanical protection. The disadvantage of this arrangement is that fixing the cuvettes to the film and removing them from the film requires rather costly and complicated solutions.

Another example of the arranged storage of cuvettes is provided in PCT appln. no. WO 2009/112692A2, where before cuvettes are dispensed they are stored arranged in cassettes containing superposed rows of cuvettes, from where an automatic device forwards them one by one to the measuring point. One of the advantages of this arrangement is the arranged storage of cuvettes ensuring mechanical protection. A disadvantage of the arrangement is that because of the special form and placement the cuvettes arranged in cassettes can be used exclusively in automatic devices that are compatible with this special form.

A further example of arranged storage of cuvettes can be found in U.S. Pat. No. 7,256,046, in which the cuvettes used for photometric analysis are placed in a radial arrangement, on discs, and the discs prepared in this way are forwarded to the measuring point one by one from their common cylindrical store, by moving them in an electronically controlled way. The disadvantage of this graceful arrangement is that the cuvettes are placed on the lower surface of the disc, which involves a risk of damage when the individual discs are forwarded. A further disadvantage of the arrangement is that on the cuvette discs, rotors, the cuvettes are situated in a radial arrangement, in the same plane, which requires special additional technical solutions for dispensing test samples and reagents and keeping them in the cuvettes.

Examples of the unarranged storage of cuvettes and dispensing cuvettes from such storage are contained in patent specification no. EP 1857820, and in U.S. Pat. No. 7,931,861 describing a version of the former patent. In this arrangement, cuvettes are lifted out from the unarranged stored set using a claw-edged feeder belt supporting the flange of the cuvettes. An advantage is that the cuvettes may be dispensed for further use from an unarranged cuvette storage not requiring preliminary arrangement. A further advantage of the arrangement is that due to the large number of cuvettes lifted out within a given period of time, the claw-edged feeder belt in automatic apparatuses performing a high number of measurements is able to supply a large amount of cuvettes. The disadvantage of the arrangement is that when the plurality of cuvettes lifted out from the unarranged storage of cuvettes is arranged using this method, the optically transparent surfaces of the cuvettes may get damaged, when they rub against the wall of the storage unit or the parts of the feeder belt or even against each other. A further disadvantage of the arrangement is that it can be used only in a few automatic devices compatible mostly with this special arrangement.

It is desirable to eliminate the disadvantages of the above solutions and to create cuvette dispensing apparatus, that is compact, technically simple, and economical, with the result that in different automatic apparatuses it realises the dispensing of cuvettes from an unarranged storage of cuvettes in a quick and simple way without requiring preliminary arrangement of the cuvettes. It is advantageous to ensure that during the dispensing of cuvettes the optically transparent surfaces of the cuvettes are exposed to scratching or abrasive effects to a lesser extent than in the case of the earlier solutions, because the cuvettes are in contact with only a few mechanical moving elements and only on a small surface.

It is further advantageous to have a cuvette dispensing apparatus that may be used in different automatic devices. In a storage place containing an unarranged plurality of cuvettes, a suitably constructed cuvette-advancing device can provide a compact, technically simple and economical possibility for elaborating a satisfactory solution. In automatic apparatuses, for the sensitive detection of different phenomena and reactions the optical purity of the optically transparent surfaces of the cuvettes is an essential parameter, and this parameter is significantly influenced by the methods of forwarding cuvettes. Therefore, the other main point is that practically, the plurality of cuvettes should be arranged side by side and then forwarded so that the cuvettes should be protected from all external effects as much as possible, in order to ensure that the optically transparent surfaces of the cuvettes are exposed to scratching or abrasive effects to a lesser extent.

The present disclosure relates to procedures for the arranged, ordered advancement of a plurality of cuvettes, the plurality of which cuvettes are stored unarranged. From the storage place, the cuvettes are forwarded for further use in an arranged way. The procedures are based on that the plurality of cuvettes stored unarranged in the storage receptacle are arranged at the bottom of a slight incline between the edges of arranging elements that are parallel to each other or are situated at an angle with respect to each other. The arrangement of the cuvettes between the edges of the arranging elements is ensured by a suitable cuvette geometry, for example cuvette flange. Then the cuvette arranging elements, members that are parallel to each other or are situated at an angle with respect to each other, together with the cuvettes arranged between their edges, are lifted up, elevated until the output opening for arranged cuvettes. Through an output opening the cuvettes arranged side by side are removed from between the edges of the cuvette arranging elements. They are forwarded for further use, and the arranging elements that are parallel to each other or are situated at an angle with respect to each other, are returned to their initial position, at the bottom of the incline.

In a favorable realisations of subject procedures, planes and/or curved plates and/or corrugated surfaces are used for creating the cuvette elevating arranging elements with edges.

In further favorable realisations of subject procedures, these arranging elements are moved in such a way that their edges are at right angles to the direction of motion or at an angle with respect to it, and the edges of the cuvette elevating arranging members are kept in the same plane while they are moved or they are placed on a curved surface.

Advantageously, during the procedure, in the interest of arrangement according to the principle of gravitation and in the interest of minimising possible damage to the cuvettes, funnelling inclines at an angle not less than 10 angular degrees and preferably not greater than 45 angular degrees are used. Although the mentioned values are believed preferable, according to the present teachings lower or higher values could be chosen when needed.

In a very favorable realisation of subject procedures, when raised, the cuvettes are removed from among the edges of the arranging elements with a moving device through the output opening for arranged cuvettes.

The present disclosure also relates to apparatus for the arranged advancement of a plurality of unarranged cuvettes. Such apparatus has a housing, and in the housing there is a storage place that is or can be partly opened and that contains a plurality of unarranged or disordered cuvettes. The apparatus has an output opening on the housing for arranged cuvettes. It has a cuvette-advancing pusher moving device, and this pusher moving device has a drive mechanism. The apparatus is constructed in such a manner that the storage place for the plurality of unarranged cuvettes has a slight incline. At the bottom of the incline along the entire width of the incline there are arranging cuvette elevator elements, that are parallel to each other, each having a respective edge, and can be lifted to elevate up until the output opening for arranged cuvettes They are placed in such a way that they may be moved up and down. The cuvette-forwarding moving device pusher is operated along the edges of the raised cuvette elevator members by the drive mechanism. The dimensions of the t distance between the edges of the arranging elements, the d diameter of the lower closed part of the cuvettes, and the p flange diameter of the neck flange of the cuvettes are determined according to the following relation:

p>t>d

In a favorable realisation of the subject apparatus, the storage receptacle contains two funnelling inclines.

An exemplary possible realisation of the apparatus according to the present disclosure may be understood in greater detail on the basis of the attached drawings and accompanying description, without restricting the claimed scope of protection to this example, where:

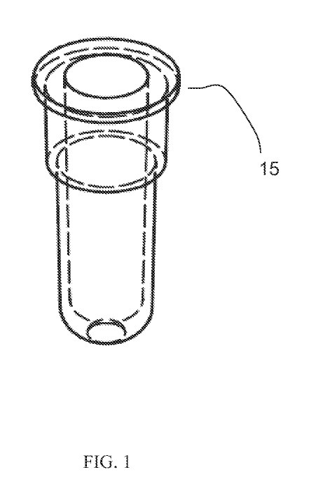

FIG. 1 is a schematic representation of a possible example of the cuvettes,

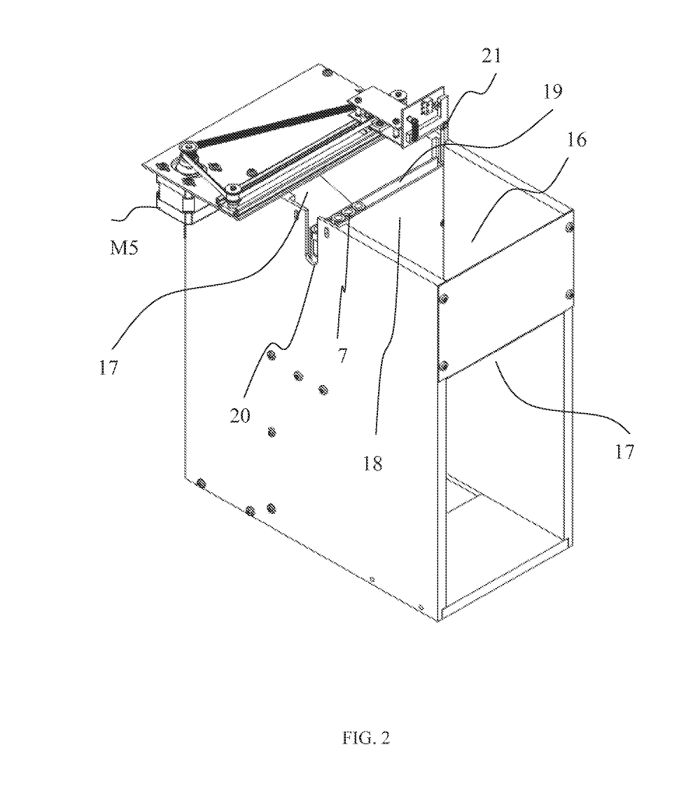

FIG. 2 is a schematic representation of the housing of a favorable practical example of the apparatus,

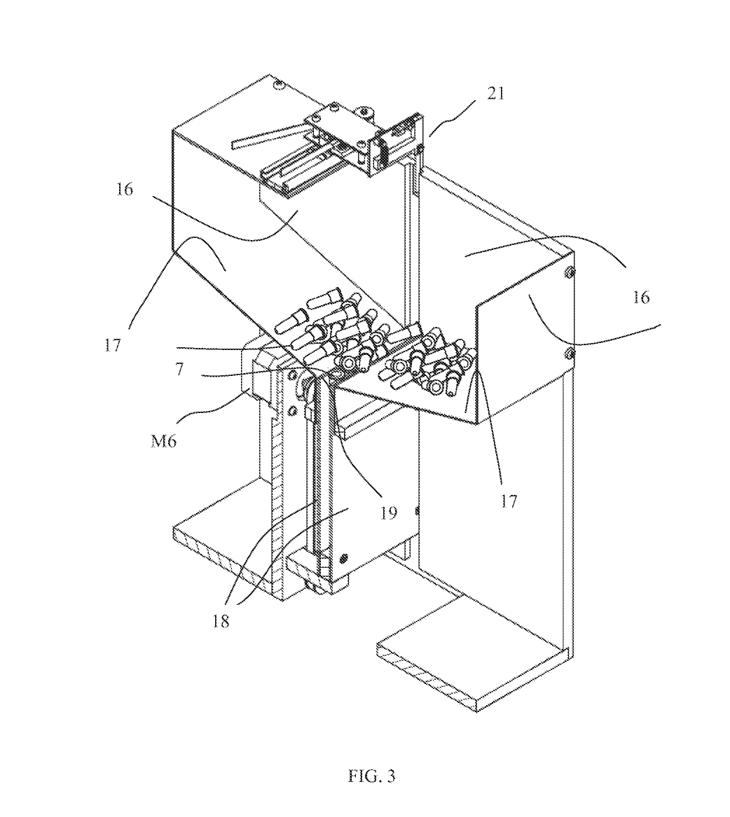

FIG. 3 is a schematic representation of the longitudinal section of the apparatus in FIG. 2, when the arranging elements are in lowered position,

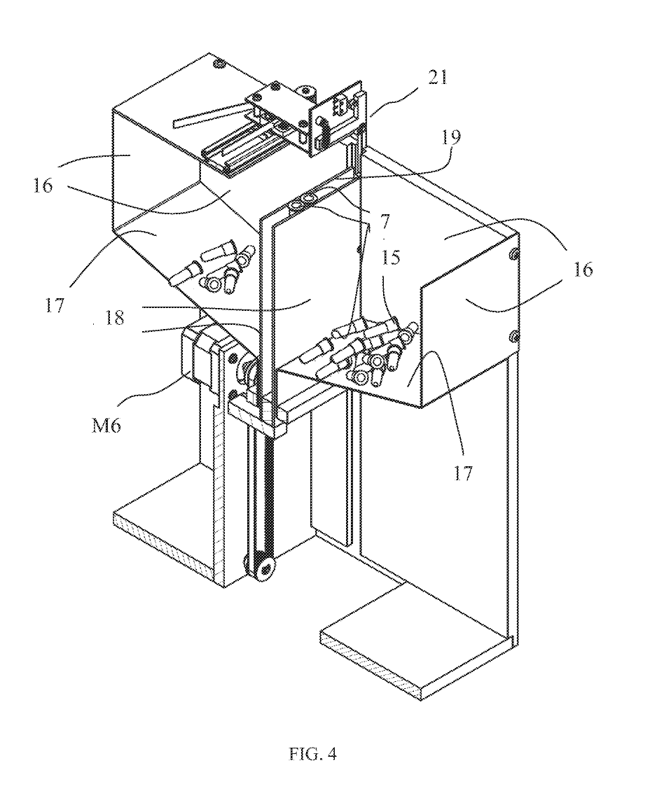

FIG. 4 is a schematic representation of the longitudinal section of the apparatus in FIG. 2, when the arranging elements are elevated,

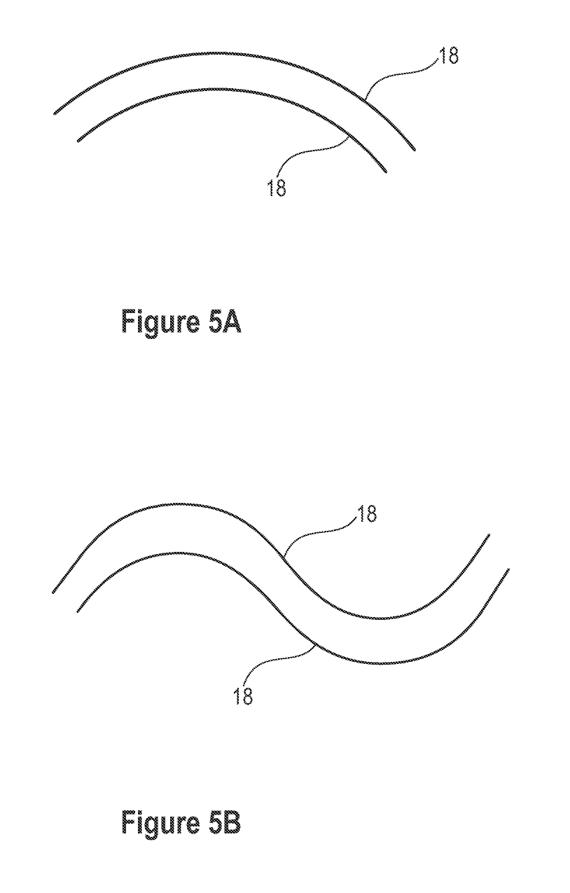

FIG. 5A presents an example of the cuvette elevator members as curved plates,

FIG. 5B presents an example of the cuvette elevator members including corrugated surfaces,

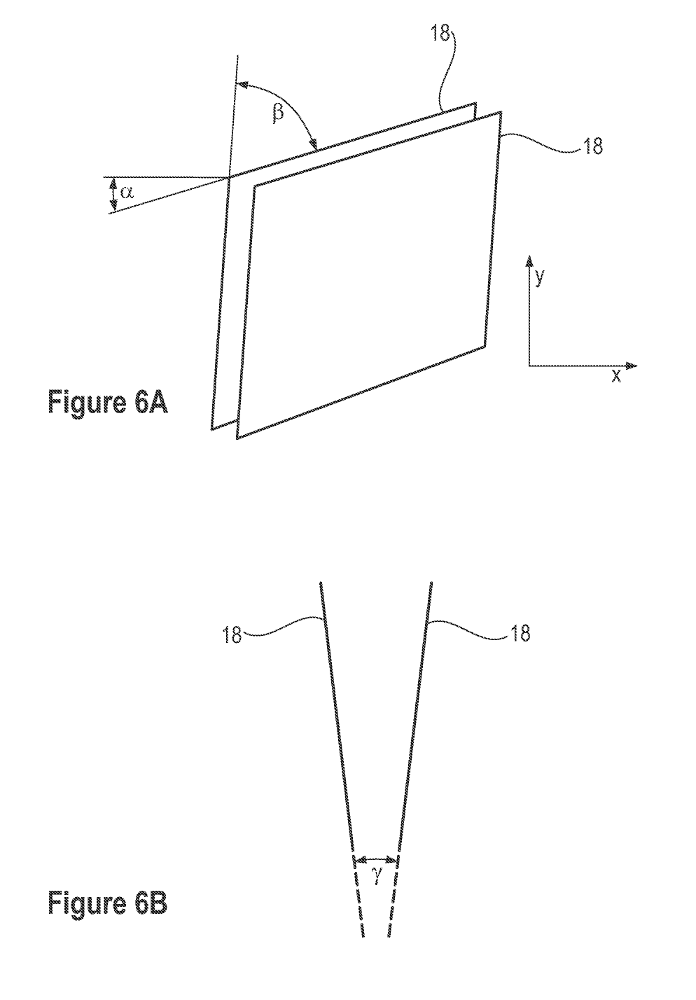

FIG. 6A shows an example of cuvette elevator members aligned at an angle with respect to direction of their motion,

FIG. 6B shows an example of cuvette elevator members situated at an angle with respect to each other; and,

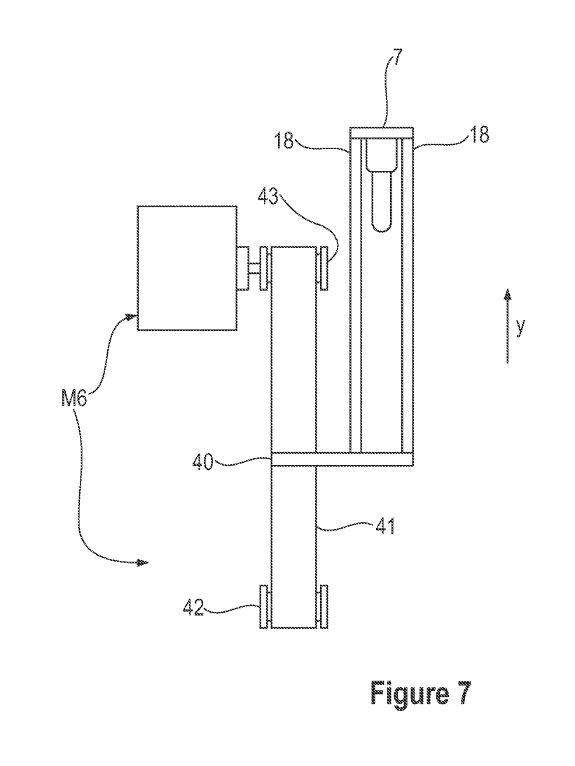

FIG. 7 is a schematic representation of the drive mechanism for the movement of the cuvette elevator members.

In the following description, numerous specific details are set forth in order to provide a thorough understanding of versions of the present invention. It will be apparent, however, to one skilled in the art that versions of the present invention may be practiced without some of these specific details. Furthermore, as used throughout this specification, the terms ‘a’, ‘an’, ‘at least’ do not denote a limitation of quantity, but rather denote the presence of at least one of the referenced item, and the term ‘a plurality’ denotes the presence of more than one referenced items.

FIG. 1 depicts a possible example of the cuvettes. A cuvette is an optically transparent cylinder or prism preferably made of glass or plastic, that is closed at the bottom and open at its top. It may have various different appearances both in respect of its geometry and size, which functions as the reaction space and storage place of the sample and reagent needed for the evaluation of the desired test. From the aspect of the operation of the apparatus forming the subject of the present patent, the most essential element of the cuvette geometry is the neck flange 15 fulfilling the theoretical requirements described in detail above.

FIGS. 2-4 are schematic representations of a favorable practical example of the apparatus according to the present disclosure. In a favorable solution of the apparatus shown in FIG. 2, a storage place or receptacle 16 with a slight incline 17 (not depicted here) is made for the plurality of unarranged cuvettes 7 (not shown here). In the center line of the storage receptacle 16 there are parallel arranging elements 18 having a respective edge 19. The apparatus also has an output opening 20 for arranged cuvettes 7, a cuvette-advancing moving device pusher 21, and a drive mechanism M5 driving the latter cuvette-advancing movements.

FIG. 3 depicts a schematic representation of the longitudinal section of the apparatus shown in FIG. 2, when the arranging cuvette elevators are in lowered position. Using the identical reference characters used in FIG. 2, it can be understood in this longitudinal sectioned drawing that the storage place 16 containing the plurality of unarranged or disordered cuvettes 7 is constructed inside as the funnelling throat of preferably two inclines 17. At the bottom of the two inclines 17, along the entire width of the two inclines 17 there are parallel arranging elements 18, members acting as cuvette elevators having respective edges 19, that may be moved up and down by the drive mechanism M6, and that can be seen in this figure in their initial position at the bottom of the two inclines 17, in lowered position accommodating a plurality of unarranged cuvettes 7. The cuvette-advancing pusher moving device is marked with reference number 21.

FIG. 4 shows a schematic representation of the longitudinal section of the apparatus shown in FIG. 2, when the arranging elements are elevated in raised position. In FIG. 4 there is a storage place 16 containing the plurality of unarranged cuvettes 7, with the funnelling throat of favourably two inclines 17 inside it, and the arranging members 18—positioned parallel to each other in the present example—each having a respective edge 19 and placed inside storage place 16. The arranging cuvette elevator elements 18—positioned parallel to each other in the present example—each having a respective edge 19 are lifted by the drive mechanism M6 up until the output opening 20 for cuvettes 7 the arranged cuvettes caught between the edges 19 of the arranging elements 18 in lowered position as shown in FIG. 3. The arranged cuvettes have a geometry, for example a cuvette 7 neck flange 15 suitable for this. From between the edges 19 of the cuvette elevator members 18 the cuvettes 7 arranged next to each other are removed by the cuvette-forwarding pusher moving device 21 at least one by one (through the output opening 20 for arranged cuvettes 7 shown in FIG. 2), for further use.

FIGS. 5A-5B present top view of cuvette elevator members 18 showing curved plates in FIG. 5A and corrugated surfaces in FIG. 5B.

FIG. 6A shows an example of cuvette elevator members 18 aligned at an angle 13 with respect to direction y (coordinate y) of their motion and further aligned at an angle α with respect to coordinate x.

FIG. 6B shows in top view an example of cuvette elevator members situated at an angle γ with respect to each other.

FIG. 7 presents an example of drive mechanism for the movement of the cuvette elevator members 18 having cuvette 7 arranged in between. According to direction of motor rotation in the drive mechanism M6, the cuvette elevator members 18 with cuvette 7 arranged in between are elevated or lowered respectively, along direction γ. The co-movement of the cuvette elevator members 18 is ensured by fixed connection 40 between the cuvette elevator members 18 and a driving belt 41 of the drive mechanism. The driving belt 41 is conveyed endlessly through the motor axis 43 and a tension roller 42 of the drive mechanism M6. It is the tension roller 42 of the driving mechanism M6 that provides for the continuous tension of the driving belt 41 necessary for error-free movement of the cuvette elevator members 18. The operation of the apparatus for the arranged dispensing of a plurality of unarranged cuvettes 7 is described below.

For the favorable operation of the apparatus, favourably the housing of the apparatus has a storage receptacle 16, that is or can be partly opened and contains a plurality of unarranged cuvettes 7. It has an output opening 20 on the housing for arranged cuvettes 7, and a cuvette-forwarding moving device 21, which device has a drive mechanism M5 (FIG. 2).

In the storage place 16 containing the plurality of unarranged cuvettes 7, preferably funnelling slight inclines 17 are created, and at the bottom of the slight inclines 17 along their entire width arranging members 18 are placed, these having a respective edge 19 and movable up and down.

In a favorable realisation the dimensions of the t distance between the edges 19 of the arranging elements 18, the d diameter of the lower closed part of the cuvettes 7, and the p flange diameter of the neck flange 15 of the cuvettes 7 are determined according to the following relation:

p>t>d

In a practical implementation, the above-mentioned arranging cuvette elevator members 18 with respective edges 19 may be surfaces positioned parallel to each other or at an angle with respect to each other.

Furthermore, the arranging members 18 with respective edges 19 may be constructed so that they may be moved up (elevated) and down, in such a manner that the edges 19 of the arranging elements 18 are at right angles to the direction of motion or at an angle with respect to it. The edges 19 of the arranging elements 18 are kept in the same plane while they are moved, or they are located on a curved surface.

In a very favorable realisation, in the initial position of the parallel arranging elements 18 with respective edges 19, the plurality of unarranged, disordered cuvettes 7 are arranged between the edges 19 of the these parallel cuvette elevator arranging elements 18 with the help of a suitable cuvette geometry, for example a cuvette neck flange 15, at the bottom of two slight inclines 17, utilizing the principle of gravitation. In following, the parallel arranging cuvette elevators 18 with respective edges 19 containing the cuvettes 7 arranged as above are lifted up, elevated until the output opening 20 for cuvettes, favourably by a drive mechanism M6. Then, from between the edges 19 of the cuvette elevators 18 the cuvettes 7 arranged next to each other in initial position are removed by the cuvette-advancing pusher moving device 21 preferably driven by a drive mechanism M5, preferably one by one, preferably through the output opening 20 for arranged cuvettes 7, for further use. The cuvette-advancing moving device 21 is operated by the drive mechanism M5 along the edges 19 of the raised arranging elements 18. The parallel arranging elements 18 with an edge 19 are returned, by lowering, to their initial position by a drive mechanism M6 (FIGS. 3, 4).

A further advantageous special feature is that in preferable implementations the arranging elements 18 with respective edges 19, that may be parallel to each other or positioned at an angle with respect to each other, may be constructed in the form of a flat and/or curved plate, and/or a corrugated surface.

Advantageously in practice there should be success in creating a technically simple and economical apparatus, that, by the ordered, arranged forwarding of a plurality of unarranged cuvettes, reduces scratching or abrasive effects on the optically transparent surfaces of the cuvettes.

Finally, it should be noted that the term “comprising” does not exclude other elements or features, and that use of the terms “a” or “an” does not necessarily exclude a plurality, in the sense that singular reference of an element does not exclude the plural reference of such elements. The verb ‘comprise’ and its conjugations do not exclude the presence of elements or steps other than those listed in any claim or the specification as a whole. The mere fact that certain measures are recited in mutually different dependent claims does not indicate that a combination of these measures cannot be used to advantage. Furthermore, elements described in association with different versions may be combined. Finally, it should be noted that the above-mentioned examples, and versions illustrate rather than limit the invention, and that those skilled in the art will be capable of designing many alternative implementations without departing from the scope of the invention as defined by the appended claims. As equivalent elements may be substituted for elements employed in claimed invention to obtain substantially the same results in substantially the same way, the scope of the present invention is defined by the appended claims, including known equivalents and unforeseeable equivalents at the time of filing of this application. Thus, in closing, it should be noted that the invention is not limited to the abovementioned versions and exemplary working examples. Further developments, modifications and combinations are also within the scope of the appended patent claims and are placed in the possession of the person skilled in the art from the present disclosure. Accordingly, the techniques and structures described and illustrated previously herein should be understood to be illustrative and exemplary, and not necessarily limiting upon the scope.

What is claimed is:

1. Apparatus for ordered forwarding of cuvettes comprising:
a cuvette storage receptacle configured to hold unarranged loose cuvettes, said storage receptacle having a bottom, said receptacle bottom having at least one cuvette funnelling inclined portion, said inclined portion having a respective bottom;
a bottom opening in said cuvette storage receptacle, said bottom opening situated at said bottom of said inclined portion;
two cuvette elevator members extending into said cuvette storage receptacle from outside and through said bottom opening, said cuvette elevator members each having a respective transverse edge running along a length of said bottom opening, said respective transverse edges of respective ones of said cuvette elevator members being separated by a distance selected to permit ordered reception of oriented cuvettes;
a cuvette elevator drive motor;
an elevator drive mechanism configured to controllably elevate and lower said cuvette elevator members, said elevator drive mechanism being operatively connected to said cuvette elevator drive motor and to said cuvette elevator members;
a cuvette output opening in said storage receptacle, said cuvette output opening extending from inside to outside of said storage receptacle, said cuvette output opening aligning with an elevation path of respective ends of said respective transverse edges of said cuvette elevators;
a cuvette pusher, said cuvette pusher mounted at a top of said cuvette storage receptacle on a path aligned with said cuvette output opening and aligned with the separation between said respective transverse edges of respective ones of said cuvette elevators;
a cuvette pusher drive motor;
a pusher drive mechanism configured to controllably move said cuvette pusher on said pusher mounting, said pusher drive mechanism being operatively connected to said cuvette pusher drive motor and to said cuvette pusher.

2. Apparatus for ordered forwarding of cuvettes as claimed in claim 1, further comprising:
said cuvette elevator members are planar plates.

3. Apparatus for ordered forwarding of cuvettes as claimed in claim 1, further comprising:
said cuvette elevator members are curved plates.

4. Apparatus for ordered forwarding of cuvettes as claimed in claim 1, further comprising:
said cuvette elevator members include corrugated surfaces.

5. The apparatus for ordered forwarding of cuvettes as claimed in claim 1, wherein:
said respective edges of said cuvette elevator members are aligned at right angles to a direction of motion of said cuvette elevator members.

6. The apparatus for ordered forwarding of cuvettes as claimed in claim 1, wherein:
said respective edges of said cuvette elevator members are aligned at an angle with respect to a direction of motion of said cuvette elevator members.

7. Apparatus for ordered forwarding of cuvettes as claimed in claim 1, further comprising:
said cuvette elevator members are situated at an angle with respect to each other.

8. The apparatus for ordered forwarding of cuvettes as claimed in claim 1, wherein:
said respective edges of said cuvette elevator members remain coplanar when moved by said elevator drive mechanism.

9. The apparatus for ordered forwarding of cuvettes as claimed in claim 1, wherein:
said respective edges of said cuvette elevator members are situated on a curved surface when moved by said elevator drive mechanism.

10. Apparatus for ordered forwarding of cuvettes as claimed in claim 1, further comprising:
a second cuvette funnelling inclined portion at said receptacle bottom.

11. The apparatus for ordered forwarding of cuvettes as claimed in claim 1, wherein:
said distance of separation (t) of said respective edges of respective ones of said cuvette elevator members is determined by the following relation,
p>t>d
where (p) is a cuvette flange diameter and (d) is a cuvette lower closed part diameter of cuvettes handled by said cuvette elevator members.

12. A process for ordered forwarding of cuvettes comprising the steps of:
storing unarranged loose cuvettes in a storage receptacle;
funnelling unarranged cuvettes to a storage receptacle bottom via funnelling inclined portions;
extending two cuvette elevator members into a storage receptacle bottom opening from outside;
providing a respective transverse edge on each respective one of the two cuvette elevator members, with these respective transverse edges being separated by a separation distance;
operating an elevator drive to controllably elevate the two cuvette elevator members upwards from the storage receptacle bottom;
transporting arranged cuvettes in a gap formed by the separation distance between the transverse edges of the cuvette elevator members;
elevating the transported cuvettes to the level of a cuvette output opening in the storage receptacle;
operating a pusher drive to controllably drive a cuvette pusher in the storage receptacle to manually expel the transported arranged cuvettes from the gap between the transverse edges and out through the cuvette output opening; and,
operating the elevator drive to return the two cuvette elevator member transverse edges to the storage receptacle bottom.

13. A process for ordered forwarding of cuvettes as claimed in claim 12, further comprising the step of:
moving the two cuvette elevator members so that their respective transverse edges lie at right angles to the direction of motion.

14. A process for ordered forwarding of cuvettes as claimed in claim 12, further comprising the step of:
moving the two cuvette elevator members so that their respective transverse edges lie at an angle with respect to the direction of motion.

15. A process for ordered forwarding of cuvettes as claimed in claim 12, further comprising the step of:
providing the respective transverse edges at an angle with respect to each other.

16. A process for ordered forwarding of cuvettes as claimed in claim 12, further comprising the step of:
providing the respective transverse edges parallel to each other.

17. A process for ordered forwarding of cuvettes as claimed in claim 12, further comprising the step of:
providing the cuvette elevator members as curved plates.

18. A process for ordered forwarding of cuvettes as claimed in claim 12, further comprising the step of:
providing the cuvette elevator members as corrugated surfaces.

19. A process for ordered forwarding of cuvettes as claimed in claim 12, further comprising the step of:
determining a distance of separation (t) of the respective edges of respective ones of the cuvette elevator members by the following relation,
p>t>d
where (p) is a cuvette flange diameter and (d) is a cuvette lower closed part diameter of cuvettes handled by said cuvette elevator members.

20. A process for ordered forwarding of cuvettes as claimed in claim 12, further comprising the step of:
locating the transverse edges on a curved surface when they are moved.
